(19) United States
(12) Patent Application Publication
(10) Pub. No.: US 2012/0249422 A1
(43) Pub. Date: Oct. 4, 2012

(54) INTERACTIVE INPUT SYSTEM AND METHOD

(75) Inventors: EDWARD TSE, Calgary (CA); MICHAEL ROUNDING, Calgary (CA); DAN GREENBLATT, Calgary (CA); DAVID HOLMGREN, Calgary (CA)

(73) Assignee: SMART TECHNOLOGIES ULC, Calgary (CA)

(21) Appl. No.: 13/077,613

(22) Filed: Mar. 31, 2011

(51) Int. Cl. G09G 5/08

(52) U.S. Cl. 345/158

(57) ABSTRACT

An interactive input system comprises an interactive surface, an illumination source projecting light onto the interactive surface such that a shadow is cast onto the interactive surface when a gesture is made by an object positioned between the illumination source and the interactive surface, at least one imaging device capturing images of a three-dimensional (3D) space in front of the interactive surface, and processing structure processing captured images to detect the shadow and object therein, and determine therefrom whether the gesture was performed within or beyond a threshold distance from the interactive surface and execute a command associated with the gesture.

### FIELD OF THE INVENTION

The present invention relates generally to an interactive system and in particular to an interactive system and a method for detecting gestures made within a three-dimensional (3D) interactive space disposed in front of an interactive surface thereof.

### BACKGROUND OF THE INVENTION

Interactive input systems that allow users to inject input such as for example digital ink, mouse events etc. into an application program using an active pointer (e.g. a pointer that emits light, sound or other signal), a passive pointer (e.g. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 6,972,401; 7,232,986; 7,236,162; and 7,274,356 and in U.S. Patent Application Publication No. 2004/0179001, all assigned to SMART Technologies ULC of Calgary, Alberta, Canada, assignee of the subject application, the entire contents of which are incorporated herein by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

“Shadow Reaching: A New Perspective on Interaction for Large Wall Displays,” authored by Garth Shoemaker et al., published in Proceedings of UIST'07, Oct. 7-10, 2007, discloses an interactive system comprising a large wall display and a method that detects the shadow of a user on the large wall display, and exploits the position of the shadow to manipulate the digital content on the display. In an embodiment of the system, a Polhemus position tracker and a Phidgets button are used to calculate the location of the shadow and to generate click events, respectively. In another embodiment of the system, a light source behind the screen and an infrared (IR) camera in front of the screen are used to capture the user's shadow.

“Body-Centric Interaction Techniques for Very Large Wall Displays,” authored by Garth Shoemaker et al., published in the Proceedings of NordiCHI 2010, discloses a method to track a user's body position using magnetic tracking components or colored balls attached to the user's joints.

U.S. Pat. No. 7,686,460 to Holmgren et al., assigned to SMART Technologies ULC discloses a projector system comprising at least two cameras that capture images of the background including the image displayed on a projection screen. The projector system detects the existence of a subject from the captured images, and then masks image data, used by the projector to project the image on the projector screen, corresponding to a region that encompasses at least the subject's eyes.

U.S. Patent Application Publication No. 2008/0013826 to Hillis et al. discloses a system and method for a gesture recognition interface system. The interface system comprises a first and second light source positioned to illuminate a background surface. At least one camera is operative to receive a first plurality of images based on a first reflected light contrast difference between the background surface and a sensorless input object caused by the first light source and a second plurality of images based on a second reflected light contrast difference between the background surface and the sensorless input object caused by the second light source. A controller is operative to determine a given input gesture based on changes in relative locations of the sensorless input object in the first plurality of images and the second plurality of images. The controller may be operative to initiate a device input associated with the given input gesture.

U.S. Patent Application Publication No. 2008/0040692 to Sunday et al. discloses a variety of commonly used gestures associated with applications or games that are processed electronically. In particular, a user's physical gesture is detected as a gesture signature. For example, a standard gesture in blackjack may be detected in an electronic version of the game. A player may hit by flicking or tapping his finger, stay by waving his hand, and double or split by dragging chips from the player's pot to the betting area. Gestures for page turning may be implemented in electronic applications for reading a document. A user may drag or flick a corner of a page of an electronic document to flip a page. The direction of turning may correspond to a direction of the user's gesture. Additionally, elements of games like rock, paper, scissors may also be implemented such that standard gestures are registered in an electronic version of the game.

U.S. Patent Application Publication No. 2009/0228841 to Hildreth discloses enhanced image viewing, in which a user's gesture is recognized from first and second images, an interaction command corresponding to the recognized user's gesture is determined, and, based on the determined interaction command, an image object displayed in a user interface is manipulated.

“Interactive Public Ambient Displays: Transitioning from Implicit to Explicit, Public to Personal, Interaction with Multiple Users,” authored by Vogel et al., published in Proceedings of UIST'04, p. 137-146, Oct. 24-27, 2004, Santa Fe, N. Mex., USA, discloses an interactive public ambient display system having four interaction phases based on the distance between a user and the display. In order to determine the position of the user, a motion tracking system with wireless passive markers positioned on body parts of the user is required.

Although interactive input systems have been considered, improvements are sought. It is therefore an object of the present invention to at least provide a novel interactive input system.

### SUMMARY OF THE INVENTION

Accordingly, in one aspect there is provided an interactive input system comprising an interactive input system comprising an interactive surface, an illumination source projecting light onto said interactive surface such that a shadow is cast onto said interactive surface when a gesture is made by an object positioned between said illumination source and said interactive surface, at least one imaging device capturing images of a three-dimensional (3D) space in front of said interactive surface, and processing structure processing captured images to detect the shadow and object therein, and determine therefrom whether the gesture was performed within or beyond a threshold distance from said interactive surface; and execute a command associated with the gesture.

In one embodiment, the processing structure detects the relative positions of the shadow and object to determine whether the gesture was performed within or beyond the threshold distance from the interactive surface. When the shadow and object overlap, the processing structure determines that the gesture is a close gesture performed within the threshold distance and when the shadow and object do not overlap the processing structure determines that the gesture is a distant gesture performed beyond the threshold distance. When the processing structure determines that the gesture was performed within the threshold distance and the processing structure receives contact data from the interactive surface that is associated with the gesture, the processing structure determines that the gesture is a direct contact gesture.

In one embodiment, the illumination source forms part of a projection unit that projects an image onto the interactive surface. The processing structure provides image data to the projection unit and updates the image data in response to execution of the command. The illumination source may be positioned on a boom extending from the interactive surface.

In one embodiment, the processing structure processes captured images to detect edges of the shadow and determine an outline of the shadow and processes captured images to determine an outline of the object. The processing structure compares the outlines to determine whether the shadow and object overlap.

According to another aspect there is provided a gesture recognition method comprising capturing images of a three-dimensional (3D) space disposed in front of said interactive surface, processing said captured images to detect the position of at least one object used to perform a gesture and at least one shadow in captured images and comparing the positions of the shadow and object to recognize the gesture type.

According to another aspect there is provided a non-transitory computer-readable medium embodying a computer program, said computer program comprising program code for processing captured images of a three-dimensional space disposed in front of an interactive surface to determine the position of at least one object used to perform a gesture and the position of at least one shadow cast onto the interactive surface, and program code comparing the positions of said shadow and the object to recognize the gesture type.

### BRIEF DESCRIPTION OF THE DRAWINGS

Embodiments will now be described more fully with reference to the accompanying drawings in which:

FIG. 1 is a partial perspective, schematic diagram of an interactive input system;

FIG. 2 is a partial side elevational, schematic diagram of the interactive input system of FIG. 1;

FIG. 3 is a block diagram showing the software architecture of the interactive input system of FIG. 1;

FIG. 4 is a flowchart showing steps performed by an input interface of the interactive input system for determining input gestures based on two-dimensional (2D) and three-dimensional (3D) inputs;

FIGS. 5A to 5D are examples of shadow detection and skin tone detection for determining 3D input;

FIG. 6 illustrates a calibration grid used during a calibration procedure for determining coordinate mapping between a captured image and a screen image;

FIG. 7 illustrates a hovering gesture;

FIG. 8 illustrates a non-contact selection gesture;

FIG. 9 shows an example of using a non-contact gesture to manipulate a digital object;

FIG. 10 shows another example of using a non-contact gesture to manipulate a digital object; and

FIGS. 11 and 12 illustrate examples of using non-contact gestures to execute commands.

### DETAILED DESCRIPTION OF THE EMBODIMENTS

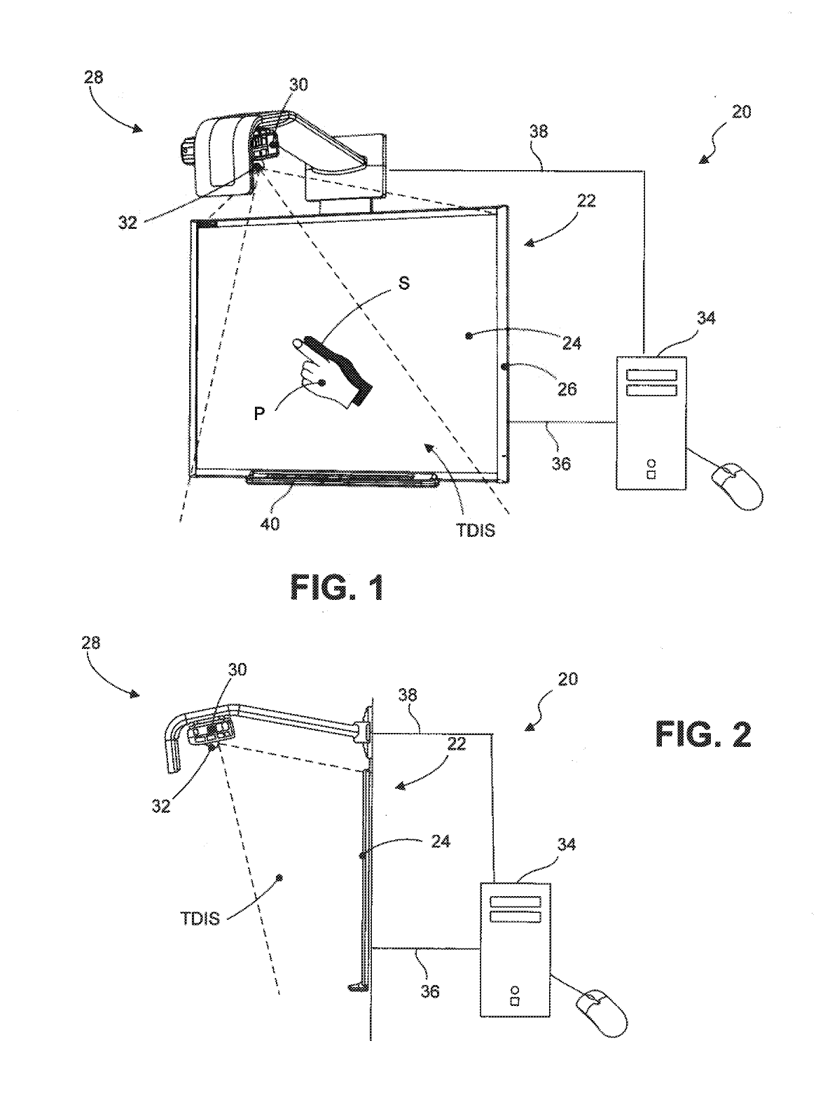

In the following, an interactive input system and method are described. The interactive input system monitors gesture activity of a user in a three-dimensional (3D) space disposed in front of an interactive surface. An illumination source projects light onto the interactive surface such that a shadow is cast onto the interactive surface when gesture activity occurs at a location between the illumination source and the interactive surface. The interactive input system determines whether the gesture activity of the user is a direct contact gesture, a close gesture, or a distant gesture. A direct contact gesture occurs when the user directly contacts the interactive surface. A close gesture occurs when the user performs a gesture in the 3D space within a threshold distance from the interactive surface. A distant gesture occurs when the user performs a gesture in the 3D space at a location beyond the threshold distance. Further specifics of the interactive input system and method will now be described with particular reference to FIGS. 1 to 12.

Turning now to FIGS. 1 and 2, an interactive input system that allows a user to perform gestures in order to inject input such as digital ink, mouse events etc. into an application program executed by a general purpose computing device is shown and is generally identified by reference numeral 20. In this embodiment, interactive input system 20 comprises an interactive board 22 mounted on a vertical support surface such as for example, a wall surface or the like. Interactive board 22 comprises a generally planar, rectangular interactive surface 24 that is surrounded about its periphery by a bezel 26. A boom assembly 28 is also mounted on the support surface above the interactive board 22. Boom assembly 28 provides support for a short throw projection unit 30 such as that sold by SMART Technologies ULC under the name “SMART Unifi 45”. The projection unit 30 projects image data, such as for example a computer desktop, onto the interactive surface 24. Boom assembly 28 also supports an imaging device 32 that captures images of a 3D space TDIS disposed in front of the interactive surface 24 and including the interactive surface 24. The interactive board 22 and imaging device 32 communicate with a general purpose computing device 34 executing one or more application programs via universal serial bus (USB) cables 36 and 38, respectively.

The interactive board 22 employs machine vision to detect one or more direct contact gestures made within a region of interest in proximity with the interactive surface 24. General purpose computing device 34 processes the output of the interactive board 22 and adjusts image data that is output to the projection unit 30, if required, so that the image presented on the interactive surface 24 reflects direct contact gesture activity. In this manner, the interactive board 22, the general purpose computing device 34 and the projection unit 30 allow direct contact gesture activity proximate to the interactive surface 24 to be recorded as writing or drawing or used to control execution of one or more application programs executed by the general purpose computing device 34.

The bezel 26 in this embodiment is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces extend in a plane generally normal to the plane of the interactive surface 24.

A tool tray 40 is affixed to the interactive board 22 adjacent the bottom bezel segment using suitable fasteners such as for example, screws, clips, adhesive etc. As can be seen, the tool tray 40 comprises a housing that accommodates a master controller and that has an upper surface configured to define a plurality of receptacles or slots. The receptacles are sized to receive one or more pen tools (not shown) as well as an eraser tool (not shown) that can be used to interact with the interactive surface 24. Control buttons (not shown) are provided on the upper surface of the housing to enable a user to control operation of the interactive input system 20. Further specifics of the tool tray 40 are described in U.S. patent application Ser. No. 12/709,424 to Bolt et al., filed on Feb. 19, 2010, and entitled “INTERACTIVE INPUT SYSTEM AND TOOL TRAY THEREFOR”, assigned to SMART Technologies ULC, the content of which is incorporated herein by reference in its entirety.

Imaging assemblies (not shown) are accommodated by the bezel 26, with each imaging assembly being positioned adjacent a different corner of the bezel. Each of the imaging assemblies has an infrared (IR) light source and an imaging sensor having an associated field of view. The imaging assemblies are oriented so that their fields of view overlap and look generally across the entire interactive surface 24. In this manner, any direct contact gesture made by a pointer, such as for example a user's finger, a cylinder or other suitable object, or a pen or eraser tool lifted from a receptacle of the tool tray 40, proximate to the interactive surface 24 appears in the fields of view of the imaging assemblies. A digital signal processor (DSP) of the master controller sends clock signals to the imaging assemblies causing the imaging assemblies to capture images frames at a desired frame rate.

During image frame capture, the DSP also causes the infrared light sources to illuminate and flood the region of interest over the interactive surface 24 with IR illumination. Thus, when no pointer exists within the fields of view of the imaging assemblies, the imaging assemblies see the illumination reflected by the retro-reflective bands of the bezel segments and capture image frames comprising a generally continuous bright band. When a pointer exists within the fields of view of the imaging assemblies, the pointer occludes IR illumination reflected by the retro-reflective bands and appears as a dark region interrupting the bright band in captured image frames. The captured image frames are processed by firmware associated with the imaging assemblies and the master controller to determine the (x, y) coordinate pair of the direct contact gesture made on the interactive surface 24. The resultant (x, y) coordinate pair is communicated by the master controller to the general purpose computing device 34 for further processing and the image data output by the general purpose computing device 34 to the projection unit 30 is updated, if required, so that the image presented on the interactive surface 24 reflects the direct contact gesture activity.

The imaging device 32 captures images of the 3D space TDIS, which defines a volume within which a user may perform close or distant gestures. When a close or distant gesture is performed by a user using an object such as for example a user's hand H within the 3D space TDIS, at a location intermediate the projection unit 30 and the interactive surface 24, the hand H occludes light projected by the projection unit 30 and thus, a shadow S is cast onto the interactive surface 24. The shadow S cast on the interactive surface 24 therefore appears in the images captured by the imaging device 32. The images captured by the imaging device 32 are sent to the general purpose computing device 34 for processing, as will be further described.

The general purpose computing device 34 in this embodiment is a personal computer or other suitable processing device comprising, for example, a processing unit, system memory (volatile and/or non-volatile memory), other non-removable or removable memory (e.g. a hard disk drive, RAM, ROM, EEPROM, CD-ROM, DVD, flash memory, etc.) and a system bus coupling the various computer components to the processing unit. The general purpose computing device 34 may also comprise networking capabilities using Ethernet, WiFi, and/or other network formats, to enable access to shared or remote drives, one or more networked computers, or other networked devices.

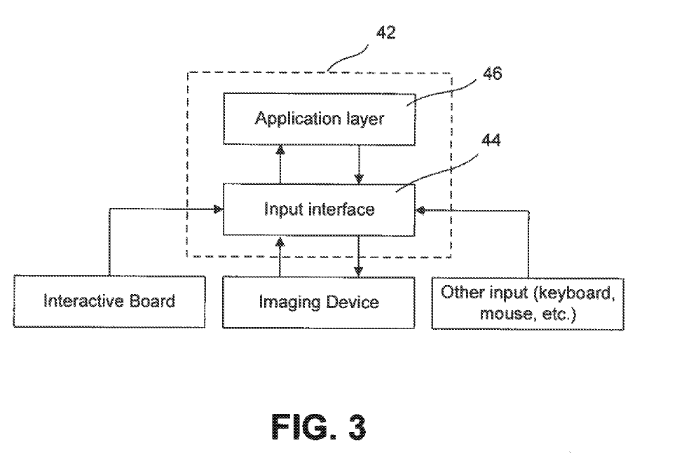

Turning now to FIG. 3, the software architecture 42 of the general purpose computing device 34 is shown. As can be seen, the software architecture 42 comprises an input interface 44 in communication with an application layer 46 executing one or more application programs. The input interface 44 receives input from the interactive board 22, controls and receives input from the imaging device 32, and receives input from standard computing input devices such as for example a keyboard and mouse. The input interface 44 processes received input to determine if gesture activity exists and if so, communicates the gesture activity to the application layer 46. The application layer 46 in turn processes the gesture activity to update, execute or control the one or more application programs.

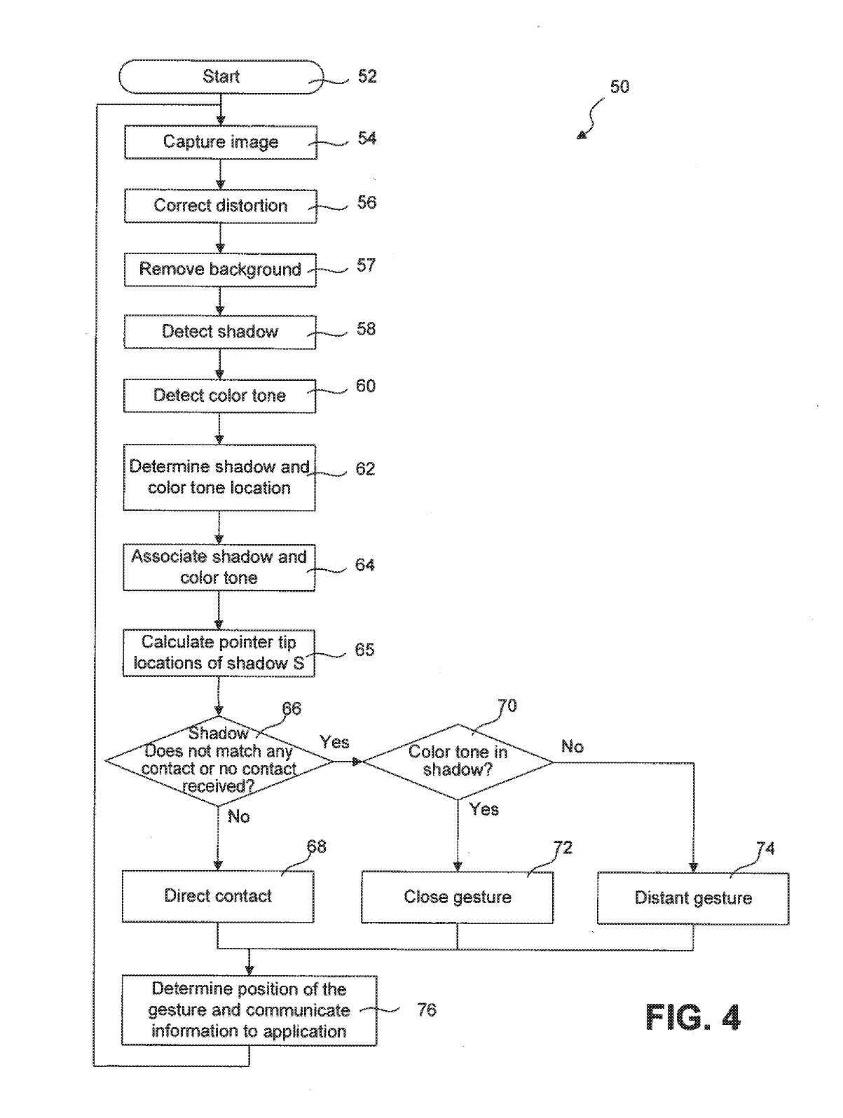

Turning now to FIG. 4, the method performed by the input interface 44 during processing of images captured by the imaging device 32 to detect gesture activity made within the 3D space TDIS is shown and is generally identified by reference numeral 50. With the interactive input system 20 powered ON (step 52), the input interface 44 controls the imaging device 32 so that the imaging device 32 captures an image of the 3D space TDIS disposed in front of the interactive surface 22, including the interactive surface 22 (step 54). The image captured by the imaging device 32 is communicated back to the input interface 44, where input interface 44 corrects the captured image for optical distortions, e.g., exposure adjustment, color balancing, lens distortion (e.g., barrel distortion), based on predetermined imaging device specifications or imaging device calibration (step 56). At this step, the input interface 44 also corrects perspective distortion using a coordinate mapping matrix that maps coordinates on the captured image to coordinates on the screen image so that after correction, the size and shape of the captured image match those of the screen image. The coordinate mapping matrix is built using a calibration process, the details of which will be discussed below.

The input interface 44 then creates a difference image by comparing the corrected image with the screen image to remove the background of the corrected image (step 57). The input interface 44 then processes the difference image to detect the presence of a shadow S cast by an object such as hand H onto the interactive surface 22 using edge detection (step 58).

The input interface 44 also processes the corrected image to detect the color tone of the hand H so that the position of the hand H may be calculated (step 60). In this embodiment, the input interface 44 posterizes the corrected image to reduce the color in each Red, Green or Blue channel thereof to two (2) tones based on a color level threshold such that, after posterization, the color in each Red, Green or Blue channel takes a value of zero (0) or one (1). Each color level threshold is obtained by averaging the color level in each Red, Green or Blue channel of the pixels in the corrected image. Those skilled in the art will appreciate that other color level thresholds, e.g., a predefined color level threshold, may alternatively be used. The input interface 44 removes the Green and Blue channels of the difference image, leaving only the Red channel, and thus the color tone of the hand H is detected.

The position of the shadow S and the position of the hand H are then calculated (step 62). In this embodiment, the input interface 44 calculates the position of the shadow S by processing the image obtained in step 58 to determine an outline extending about the periphery of the shadow S. The input interface 44 also calculates the position of the hand H using the detected color tone as obtained in step 60 to determine an outline enclosing the periphery of the hand H.

The input interface 44 then associates the shadow S with the hand H (step 64). In the event that one shadow S and one hand H appear in the captured image, the input interface 44 automatically associates the shadow S with the hand H. In the event that more than one shadow and more than one hand appear in the captured image, the input interface 44 determines which shadow is associated with which hand. In this embodiment, the input interface 44 compares the position of each shadow obtained in step 62 with the position of each hand obtained in step 62. Each shadow is paired with a hand based on the proximity thereto. Specifically, the input interface 44 compares all hand positions with all shadow positions, and pairs each hand with the nearest shadow. As will be appreciated, the shadow and hands may be paired with one another based on other criteria such as for example shape, size, etc.

The input interface 44 further processes the image obtained in step 58 to determine the positions of the shadow S that correspond to the finger tip locations of the hand H (hereinafter referred to as the shadow finger tips) (step 65). In this embodiment, the input interface 44 determines the peak locations of the outline of the shadow S by identifying the points on the outline that have an angle of curvature larger than a threshold. The input interface 44 checks each peak location to determine whether the peak location overlaps with the color tone of its associated hand H, and if so, the peak location is eliminated. The remaining peak locations are determined to correspond to one or more shadow finger tips and the screen image coordinate positions of the shadow finger tips are calculated.

As mentioned previously, the input interface 44 transforms each received (x, y) coordinate pair received from the interactive board 22 representing the position of a direct contact made by the user on the interactive surface 24 to an (x, y) screen image coordinate pair through the use of the coordinate mapping matrix. The input interface 44 then compares each (x, y) screen image coordinate pair with the calculated screen image coordinate positions of the shadow finger tips (step 66).

If an (x, y) coordinate pair has been received from the interactive board 22 and it is determined that the positions of the shadow finger tips are proximate one of the (x, y) screen image coordinate pairs, the shadow S is determined to be associated with that (x, y) screen image coordinate pair and the gesture is interpreted as a direct contact gesture on the interactive surface 24 (step 68). The input interface 44 then communicates the position of the (x, y) coordinate pair and information indicating that the gesture is a direct touch gesture to the application layer 46 (step 76). The application layer 46 in turn processes the position of the (x, y) coordinate pair and the information that the gesture is a direct touch gesture to update, execute or control one or more application programs and the input interface 44 returns to step 54 to condition the imaging device 32 to capture another image of the 3D space TDIS.

If, however, during the comparison at step 66, it is determined that no shadow finger tip positions are proximate any of the (x, y) screen image coordinate pairs, or if no (x, y) coordinate pairs have been received from the interactive board 22, the gesture is interpreted as either a close gesture or a distant gesture. In this case, the input interface 44 checks the position of the shadow S to determine whether the position of the shadow S as obtained in step 62 overlaps with the position of its associated hand H, by comparing the coordinates obtained in step 62 (step 70).

If the position of the shadow S overlaps with the position of its associated hand H signifying that the user is positioned within a short distance (e.g., within approximately 3 feet) from the interactive surface 24, the gesture is interpreted as a close gesture (step 72). The input interface 44 then communicates the position of the shadow S and information indicating that the gesture is a close gesture to the application layer 46 (step 76). The application layer 46 in turn processes the position of the shadow S and the information that the gesture is a close gesture to update, execute or control one or more application programs and the input interface 44 returns to step 54 to condition the imaging device 32 to capture another image of the 3D space TDIS.

If, at step 70, the position of the shadow S does not overlap with the position of its associated hand H signifying that the user is positioned at a far distance (e.g., beyond approximately 3 feet) from the interactive surface 24, the gesture is interpreted as a distant gesture (step 74). The input interface 44 then communicates the position of the shadow S and information indicating that the gesture is a distant gesture to the application layer 46 (step 76). The application layer 46 in turn processes the position of the shadow S and the information that the gesture is a distant gesture to update, execute or control one or more application programs and the input interface 44 returns to step 54 to condition the imaging device 32 to capture another image of the 3D space TDIS.

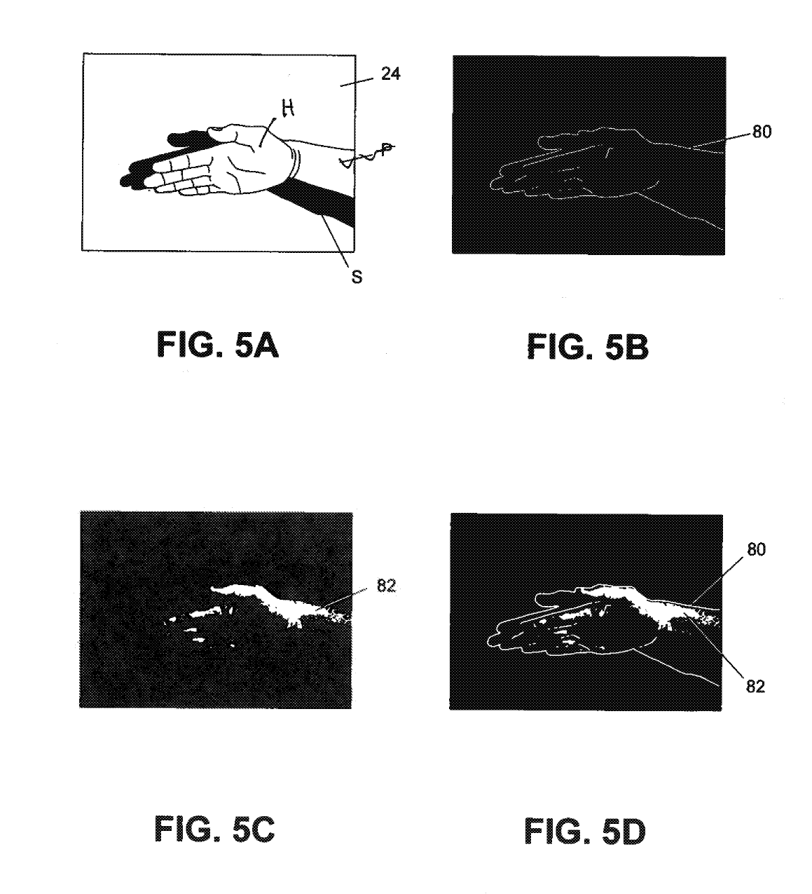

An example of an image captured and processed according to method 50 will now be described with reference to FIGS. 4 and 5A to 5D. An image of the 3D space TDIS that has been captured by imaging device 32 (step 54) and processed by the input interface 44 to correct for optical distortions, e.g. exposure adjustment, color balancing, lens distortion, etc. (step 56) is shown in FIG. 5A. As can be seen, the corrected image comprises a hand H and a shadow S of the hand H cast onto the interactive surface 24. Although not shown in FIG. 5A, in this embodiment, the imaging device 32 captures images in color.

The corrected image shown in FIG. 5A is further processed by the input interface 44 to create a difference image by comparing the screen image with the corrected image of FIG. 5A, to remove the background (step 57). The input interface 44 processes the difference image to detect the presence of the shadow S using edge detection, as shown in FIG. 5B. As can be seen, the resulting image comprises an outline 80, which as will be appreciated may be the outline of shadow S (in the event of a distant gesture) or the combined outline of the shadow S and hand H (in the event of a direct contact gesture or a close gesture). The periphery of the outline 80 identifies both the location and size of the shadow S.

The corrected image shown in FIG. 5A is processed by the input interface 44 to detect the color tone of the hand H (step 60) as shown in FIG. 5C, by removing the Green and Blue channels, as described above. As can be seen, the resulting image comprises a lightened region 82, representing the skin tone of the hand H, appearing on a dark background.

The input interface 44 then calculates the position of the hand H and the shadow S by processing the images of FIGS. 5B and 5C (step 62). In this example, the input interface 44 determines that only one hand H and one shadow S are present in the captured image, and thus the hand H is associated with the shadow S (step 64). Also, in this example, no (x, y) coordinate pairs have been received by the input interface 44, and thus the gesture is interpreted as either a close gesture or a distant gesture (step 66).

The input interface 44 then determines if the shadow S overlaps with its associated hand H (step 70) by comparing the positions of the shadow S and hand H obtained in step 62. An exemplary image illustrating the comparison is shown in FIG. 5D, which has been created by superimposing the images of FIGS. 5B and 5C. As can be seen, the position of the shadow S overlaps with the position of its associated hand H. Thus, the gesture is interpreted as a close gesture (step 72), and it is assumed that the gesture has been performed by a user positioned within a short distance (e.g., less than 3 feet) from the interactive surface 24. The input interface 44 then communicates the position of the shadow S and information indicating that the gesture is a close gesture to the application layer 46 (step 76). The application layer 46 in turn processes the position of the shadow S and the information that the gesture is a close gesture to update, execute or control one or more application programs and the input interface 44 returns to step 54 to condition the imaging device 32 to capture another image of the 3D space TDIS as described above.

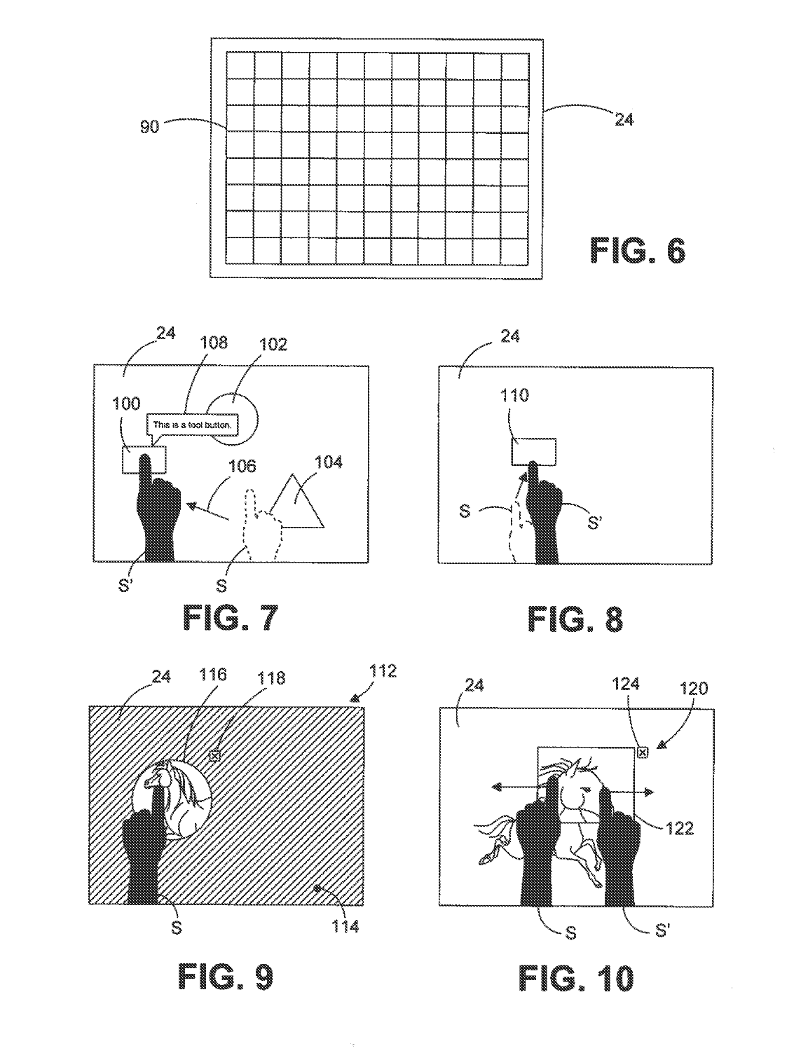

As will be appreciated, the image projected by the projection unit 30 onto the interactive surface 24 may be distorted compared to the image sent by the general purpose computing device 34 to the projection unit 30, due to effects such as keystoning caused by imperfect alignment between the projection unit 30 and the interactive surface 24. To correct for such distortion, the input interface 44 maintains the coordinate mapping matrix that maps captured image coordinates to screen image coordinates as described previously. The coordinate mapping matrix is built using a calibration process, as will now be described with reference to FIG. 6. During calibration, the input interface 44 provides a calibration image, which in this embodiment comprises a grid 90 having predefined dimensions, to the projection unit 30 for display on the interactive surface 24. The imaging device 32 is then conditioned to capture an image of the interactive surface 24, and transmit the captured image to the input interface 44. The input interface 44 in turn processes the captured image to identify the grid, compares the identified grid with the grid in the calibration image and calculates the coordinate mapping matrix. The coordinate mapping matrix is then saved and used to transform captured image coordinates to screen image coordinates.

Distinguishing the above-mentioned three types of gestures, i.e., direct contact gestures, close gestures and distant gestures, allows input interface 44 and application layer 46 to apply different position precision criteria in gesture recognition to differentiate commands associated with each type of gesture. Direct contact gestures may be used for executing commands with precise location requirements such as for example navigation among a list of content (e.g., navigating to a particular page or paragraph of an e-book), highlighting text or graphics, selecting a tool from a toolbar or tool set, writing, moving a mouse cursor to a precise location, and precise manipulation of digital objects. If a direct contact gesture is detected, an application program may apply the gesture at the precise contact position.

Close gestures may be used for executing commands with less precise location requirements such as for example, fast navigation through a list of content, highlighting content of relatively large size (e.g., a paragraph or a relatively large image), selecting a large tool icon and moving a window. In some embodiments, application programs that accept close gestures may provide large size icons, menus, text and images to facilitate use of close gestures.

Distant gestures may be used for executing commands with the least precise location requirements such as for example, fast navigation through a list of content, highlighting a large area of content (e.g., a page of an e-book) and blanking a display area.

Differentiating commands based on the type of gesture provides increased flexibility, as the same gesture performed by a user may be interpreted in a variety of ways depending on whether the gesture is a direct contact gesture, a close gesture or a distant gesture. For example, the same gesture performed in direct contact with the interactive surface 24 (i.e., as a direct contact gesture), near the interactive surface 24 (i.e., as a close gesture), or at a distance from the interactive surface 24 (i.e., as a distant gesture) may be recognized as different gestures associated with different commands, as will be further discussed below.

FIG. 7 illustrates a hovering gesture, which is defined as a hand move within the 3D space TDIS without contacting the interactive surface 24. In this example, image data comprising digital objects 100 to 104 is projected onto the interactive surface 24. A user places their hand within the 3D space TDIS without contacting the interactive surface 24. As a result, the shadow S of the user's hand is cast onto the interactive surface 24. The input interface 44 detects the finger tip positions of the shadow S as described above. When the user performs a gesture by moving their hand in a direction indicated by arrow 106 such that the shadow is moved to the position identified by S′, the finger tip portion of shadow S′ overlaps object 100. The input interface 44 detects the movement of the shadow, and interprets it as a hovering gesture. As a result, text 108 appears on the interactive surface 24 providing information to the user regarding object 100.

In an alternative embodiment, the hovering gesture described above corresponds to a mouse hovering gesture (i.e., moving a mouse with no mouse button pressed), and causes a mouse cursor (not shown) to move following the finger tip portion of the shadow from shadow position S to shadow position S′.

FIG. 8 illustrates a selection gesture which can be used, for example, to select an object or click a button. As can be seen, an image of a digital object 110 is projected onto the interactive surface 24. When a user places their hand within the 3D space TDIS without contacting the interactive surface 24, the shadow S of the user's hand is cast onto the interactive surface 24. The input interface 44 detects the finger tip portion of the shadow S as described previously.

In this example, the user performs a gesture with their hand by moving their hand so that the shadow S′ moves towards the digital object 110. When the finger tip portion of the shadow crosses the edge of the digital object 110 at a speed slower than a threshold, the input interface 44 interprets the gesture as a selection gesture and thus the digital object 110 is selected, similar to clicking a button on a computer mouse to select an icon. Depending on the property of the digital object 110, the gesture may be further interpreted by the application layer 46 to execute a command. For example, if the digital object 110 is an icon to be selected to open up a computer application program, once the digital object 110 is selected, the application layer 46 will open up the computer application program. As another example, if the digital object 110 is a shape associated with an already open computer application program, the gesture is interpreted as a selection, and the shape can be moved on the interactive surface by the user.

FIG. 9 shows an example of using a non-contact gesture (i.e., a close or distant gesture) to manipulate a digital object. As can be seen, a spot light tool 112 is projected onto the interactive surface 24. The spot light tool 112 comprises a shaded area 114 covering a background image, a spot light window 116 that reveals a portion of the background image, and a close button 118 that may be selected to close the spot light tool 112. The spot light window 116 may be dragged around the interactive surface 24 to reveal different portions of the background image. When a user places their hand within the 3D space TDIS (not shown) without contacting the interactive surface 24, the shadow S of the user's hand is cast onto the interactive surface 24. The input interface 44 detects the finger tip portion of the shadow S as described previously. In the example shown, the shadow S overlaps the spotlight window 116 and thus, when the user performs a gesture by moving their hand around the 3D space TDIS such that the shadow S moves around the interactive surface 24, the spotlight window 116 also moves following the shadow S revealing different portions of the background image as the spotlight window 116 moves.

FIG. 10 shows another example of using a non-contact gesture (i.e., a close or distant gesture) to manipulate a digital object. In this example, a magnifier tool 120 is launched by a user, which comprises a zoom window 122 zooming in on a portion of an image projected onto the interactive surface 24, and a close button 124 that may be selected to close the magnifier tool 120. When a user places two (2) hands within the 3D space TDIS without contacting the interactive surface 24, the shadows S and S′ of the user's hands are cast onto the interactive surface 24. In this example, the shadows S and S′ overlap the image projected on the interactive surface 24. The user performs a gesture by moving their hands either towards one another or away from one another resulting in the distance between the shadows S and S′ either decreasing or increasing. In the event the distance between the shadows S and S′ is increased, the input interface 44 interprets the shadow movement as a zoom in, and as a result the image positioned within the zoom window 122 is magnified. In the event the distance between the shadows S and S′ is decreased, the input interface 44 interprets this shadow movement as a zoom out, and as a result the image positioned within the zoom window 122 is demagnified.

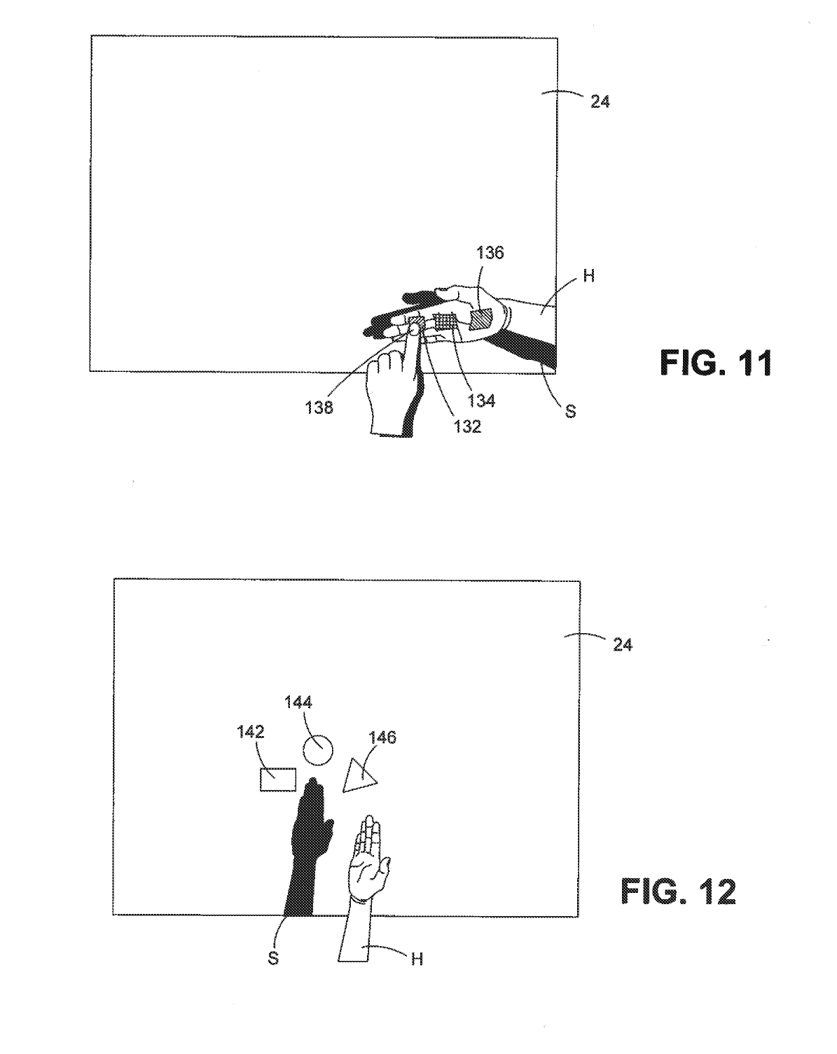

FIG. 11 illustrates an example of using a close gesture to execute commands. A user places their open hand H within the 3D space TDIS such that a shadow S of the open hand H is cast onto the interactive surface 24. The input interface 44 detects the skin tone and the shadow S of the hand H, and determines that the gesture is a close gesture. The input interface 44 also checks if the shape of the shadow S matches a predefined pattern, which in this embodiment is an open hand shape pattern. If the shape of the shadow S matches the predefined pattern, which is true in the example shown in FIG. 11, a set of tool icons 132 to 136 is projected onto the open hand H. The user may then select a tool icon, such as for example tool icon 132, by moving a finger on their hand across the tool icon 132 at a slow speed. The input interface 44 detects the skin tone of the finger, and determines if the finger crosses the tool icon 132 at a speed slower than a threshold and if so, tool icon 132 is selected. In this embodiment, the set of tool icons 132 to 136 moves with the position of the hand H such that set of tool icons 132 to 136 is always projected onto the hand H. When the user removes their hand H from the 3D space TDIS, or the shadow S of the hand H no longer matches the predefined pattern, the set of tool icons 132 to 136 is no longer projected.

FIG. 12 shows another example of using a distant gesture to execute commands. A user places their open hand H within the 3D space TDIS such that the shadow S of the open hand is cast onto the interactive surface 24. The input interface 44 detects the skin tone and the shadow S of the hand H, and since there is no overlap, determines that the gesture is a distant gesture. The input interface 44 also checks if the shape of the shadow S matches a predefined pattern, which in this embodiment is an open hand shape pattern. If the shape of the shadow S matches the predefined pattern, which is true in the example shown in FIG. 12, a set of tool icons 142 to 146 is projected onto the interactive surface 24, at locations proximate to the position of the shadow S. In this embodiment, the set of tool icons 142 to 146 moves with the position of the shadow S such that the set of tool icons 142 to 146 is always projected proximate to shadow S. When the user removes their hand H from the 3D space TDIS, or the shadow S of the hand H no longer matches the predefined pattern, the set of tool icons 142 to 146 remains projected on the interactive surface 24 such that the user may perform a second gesture to select at least one of the tool icons 142 to 146. To remove the set of tool icons 142 to 146, the user may perform a remove gesture by making a sweeping motion with their hand. The remove gesture may be any one of a direct contact gesture, a close gesture or a distant gesture. In another embodiment, the set of tool icons 142 to 146 may also have a “remove tools” icon projected therewith, which may be in the form of text or image, such as for example an “X”. A user may perform a selection gesture to select the “remove tools” icon.

Those skilled in the art will appreciate that other types of non-contact gestures may be used to execute commands. For example, an application may display one or more special icons onto the interactive surface 24 for selection by a user. A user may select one of the special icons by performing, for example, a close gesture. Once the special icon is selected, a set of tool icons may be projected onto the hand H, similar to that described above.

Those skilled in the art will appreciate that various alternative embodiments are readily available. For example, when the shadow of a hand overlaps with an object to trigger the display of an associated tool icon set, the tool icon set may be displayed in high contrast. In another embodiment, the input interface 44 may distinguish a non-contact selection gesture from a mouse selection gesture, and will only allow objects to be selected using non-contact selection gestures.

Those skilled in the art will appreciate that various selection methods may also be employed. For example, a user may perform a selection gesture by first moving their hand such that the shadow of the hand is cast onto the interactive surface 24, until their finger overlaps a digital object. The user may then perform a selection gesture by moving their hand towards the interactive surface 24, causing the size of the shadow S to shrink. The input interface 44 in this case processes the successive captured images received from imaging device 32 to determine if the size of the shadow S′ is smaller than a threshold percentage of the shadow S. If so, the input interface 44 interprets the gesture as a selection gesture and thus the digital object is selected, similar to clicking a button on a computer mouse to select an icon. In another embodiment, a user may perform a selection gesture by positioning the shadow of their finger such that it overlaps with a digital object projected onto the interactive surface 24. The input interface 44 then starts a timer to count the length of time the shadow overlaps the digital object. When a predefined time threshold has passed, such as for example two (2) seconds, the input interface 44 interprets the gesture as a selection gesture and thus the digital object is selected.

Although the interactive input system is described as detecting a gesture made by a single user, those skilled in the art will appreciate that the interactive input system may be utilized to detect gestures made by multiple users. In this embodiment, the imaging device 32 captures images and the input interface 44 processes the captured images to detect skin tones and shadows, and to match skin tones to respective shadows by recognizing and matching the shapes thereof. As a result, multiple users may use the interactive input system at the same time. In another embodiment, the interactive board 22 may recognize multiple concurrent touches brought into contact with the interactive surface 24. Therefore, multiple users may perform direct contact or non-contact (close or distant) gestures at the same time.

Although the input interface is described as obtaining the color tone of the hand by removing the Green and Blue channels from the difference image, those skilled in the art will appreciate that other techniques are available for determining skin tone in captured images. For example, color tone detection technologies using normalized lookup tables, Bayes classifiers, Gaussian models or elliptic boundary models, as described in the publication entitled “A Survey on Pixel-Based Skin Color Detection Techniques” authored by Vezhnevets, et al., published in Proceedings of the GraphiCon 2003 (2003), pp. 85-92, may be used.

Although the input interface 44 is described as interpreting input received from the imaging device 32 and the interactive surface 24 as gestures, those skilled in the art will appreciate that the input interface 44 may communicate the input to one or more application programs in the application layer as gesture interpretation. As will be appreciated, each application program may interpret the input as a different gesture, that is, the same input may be interpreted as a different gesture by each application program.

The gesture recognition methodologies described above may be embodied in a computer program comprising program modules including routines, object components, data structures and the like and may be embodied as computer-readable program code stored on a non-transitory computer-readable medium. The computer-readable medium is any data storage device. Examples of computer-readable media comprise for example read-only memory, random-access memory, CD-ROMs, magnetic tape, USB keys, flash drives, optical storage devices etc. The computer-readable program code can also be distributed over a network including coupled computer systems so that the computer-readable program code is stored and executed in a distributed fashion.

Although the interactive board 22 is described as being mounted on a vertical support surface, those skilled in the art will appreciate that the interactive board may be supported on a stand or other suitable framework or suspended from overhead structure. Of course interactive boards employing other machine vision configurations, analog resistive, electromagnetic, capacitive, acoustic or other technologies to register input may be employed. Also, rather than taking a vertical configuration, the interactive board may be in the form of a touch table comprising a horizontally oriented interactive surface.

Although the interactive input system is described as utilizing a front-mounted projector, those skilled in the art will appreciate that alternatives are available. For example, a touch sensitive display device such as for example a touch sensitive liquid crystal display (LCD) panel may be used as the interactive board. In this embodiment, an illumination source would be used to project light onto the surface of the interactive board such that a shadow is cast onto the interactive surface when a gesture is performed at a location between the illumination source and the interactive surface.

Although gestures are described as being made by a user's hands, those skilled in the art will appreciate that other objects may be used to perform gestures. For example, a passive pointer such as a pen, a stylus comprising a machine recognizable pattern (e.g., a bar code pattern or the like printed thereon, a pattern of IR light emitted from the tip of an IR light source), or coupling with an appropriate position sensing means, may be used.

Although a single imaging device is described as capturing images of the 3D space TDIS including the interactive surface 24, those skilled in the art will appreciate that two or more imaging devices may be used. For example, a system using two cameras facing towards the interactive surface 24 to detect shadows such as that disclosed in U.S. Pat. No. 7,686,460 to Holmgren, et al., assigned to SMART Technologies ULC, the content of which is incorporated herein by reference in its entirety, may be used. As another example, the system may have two cameras positioned near the interactive surface, with each of the cameras having a field of view looking generally outward from the interactive surface and into the 3D space and capturing images thereof. In this embodiment, the input interface 44 detects the user's arms and hands from the captured images and calculates the distance between each hand and the interactive surface. Close gestures and distant gestures can then be determined based on the calculated distance.

Although the interactive input system is described as utilizing an interactive board 22 to generate (x, y) coordinates of a touch contact, those skilled in the art will appreciate that the system may operate without the interactive board 22. In this embodiment, the system is able to determine gesture activity in the form of a close or distance gesture.

Although a USB cable is described as coupling the general purpose computing device 34 to the imaging device 32 and the interactive board 22, those skilled in the art will appreciate that alternative wired connections, such as for example VGA, DVI, HDMI may be employed.

Those skilled in the art will appreciate that, in some alternative embodiments, direct contact gestures and close gestures may also be used to execute commands with the least precise requirements. For example, commands requiring the least precision requirements, such as for example blanking a display area, may be executed in the event of a close gesture.

In other embodiments, the coordinate mapping matrix may be built using a calibration procedure, such as that described in U.S. Pat. No. 5,448,263 to Martin and assigned to SMART Technologies ULC, the content of which is incorporated herein by reference in its entirety.

Although embodiments have been described above with reference to the accompanying drawings, those skilled in the art will appreciate that variations and modifications may be made without departing from the spirit and scope thereof as defined by the appended claims.

What is claimed is:

1. An interactive input system comprising:
an interactive surface;
an illumination source projecting light onto said interactive surface such that a shadow is cast onto said interactive surface when a gesture is made by an object positioned between said illumination source and said interactive surface;
at least one imaging device capturing images of a three-dimensional (3D) space in front of said interactive surface; and
processing structure processing captured images to:
detect the shadow and object therein, and determine therefrom whether the gesture was performed within or beyond a threshold distance from said interactive surface; and
execute a command associated with the gesture.

2. An interactive input system according to claim 1 wherein said processing structure detects the relative positions of the shadow and object to determine whether the gesture was performed within or beyond the threshold distance from said interactive surface.

3. An interactive input system according to claim 2 wherein when the shadow and object overlap, the processing structure determines that the gesture is a close gesture performed within the threshold distance and when the shadow and object do not overlap the processing structure determines that the gesture is a distant gesture performed beyond the threshold distance.

4. An interactive input system according to claim 3 wherein when the processing structure determines that the gesture was performed within the threshold distance and the processing structure receives contact data from the interactive surface that is associated with the gesture, the processing structure determines that the gesture is a direct contact gesture.

5. The interactive input system of claim 4 wherein said processing structure compares the position of the touch contact on the interactive surface to the position of the shadow cast on said interactive surface to determine if said shadow is associated with said contact data.

6. The interactive input system of claim 1 wherein said illumination source forms part of a projection unit, said projection unit projecting an image onto said interactive surface.

7. The interactive input system of claim 6 wherein said processing structure provides image data to said projection unit.

8. The interactive input system of claim 7 wherein said processing structure updates image data provided to said projection unit in response to execution of said command.

9. The interactive input system of claim 1 wherein said interactive surface is generally rectangular.

10. The interactive input system of claim 9 wherein said illumination source is positioned on a boom extending from said interactive surface.

11. The interactive input system of claim 10 wherein said at least one imaging device is positioned on said boom adjacent to said illumination source.

12. The interactive input system of claim 11 wherein said boom extends from a top edge of said interactive surface.

13. The interactive input system of claim 12 wherein said illumination source forms part of a projection unit, said projection unit projecting an image onto said interactive surface.

14. The interactive input system of claim 13 wherein said processing structure provides image data to said projection unit.

15. The interactive input system of claim 14 wherein said processing structure updates said image data provided to said projection unit in response to execution of said command.

16. The interactive input system of claim 3 wherein said processing structure processes captured images to detect edges of the shadow and determine an outline of the shadow and processes captured images to determine an outline of the object, said processing structure comparing the outlines to determine whether the shadow and object overlap.

17. The interactive input system of claim 16 wherein the object is a user's hand and wherein the processing structure detects color tone in captured images to determine the outline of the user's hand.

18. The interactive input system of claim 17 wherein the processing structure detects color tone by posterizing captured images to reduce colors in said captured images.

19. A gesture recognition method comprising:
capturing images of a three-dimensional (3D) space disposed in front of said interactive surface;
processing said captured images to detect the position of at least one object used to perform a gesture and at least one shadow in captured images; and
comparing the positions of the shadow and object to recognize the gesture type.

20. The method of claim 19 wherein during the comparing, when the shadow and object overlap, the gesture is recognized as a close gesture and when the shadow and object do not overlap, the gesture is recognized as a distant gesture.

21. The method of claim 20 when during the comparing, when the shadow and object overlap and contact with an interactive surface associated with the object is detected, the gesture is recognized as a direct contact gesture.

22. The method of claim 19 wherein said processing further comprises correcting said captured images for optical distortions.

23. The method of claim 22 wherein said processing further comprises detecting edges of said shadow and determining an outline of said shadow and detecting an outline of the object and wherein said comparing comprises comparing the outlines to detect overlap.

24. The method of claim 22 wherein the object is a hand and wherein detecting an outline of the hand further comprises detecting a color tone of said hand.

25. The method of claim 24 wherein detecting an outline of the hand further comprises posterizing captured images to reduce colors.

26. A non-transitory computer-readable medium embodying a computer program, said computer program comprising:
program code for processing captured images of a three-dimensional space disposed in front of an interactive surface to determine the position of at least one object used to perform a gesture and the position of at least one shadow cast onto the interactive surface; and
program code comparing the positions of said shadow and the object to recognize the gesture type.
